(19) United States
(12) Patent Application Publication
(10) Pub. No.: US 2014/0060393 A1
(43) Pub. Date: Mar. 6, 2014

(54) FOLDABLE SUPPORT APPARATUS

(71) Applicant: Eagle FAN, Hsin-chu City (TW)

(72) Inventor: Eagle FAN, Hsin-chu City (TW)

(21) Appl. No.: 13/604,211

(22) Filed: Sep. 5, 2012

(51) Int. Cl. A47B 21/013; F16M 11/38; A47B 23/00

(52) U.S. Cl. 108/3; 248/166

(57) ABSTRACT

A foldable support apparatus is provided, including a join unit and a support frame. The support frame is coupled to the joint unit. The support frame includes two multi joint sets, with one multi-joint set further including a first arm, a first leg and a first foot, and the other multi joint set including a second arm, a second leg and a second foot. When folded, all components will be aligned close together to save space. When expanded, the first leg, the first arm, the second arm and the second leg form a ∩-shape. The first foot coupled to the first leg and the second foot coupled to the second leg are responsible for supporting and maintaining the standing angle of the aforementioned ∩-shape. As such, the user can use the present invention in bed, on floor or outdoor lawn to support and fasten portable electronic device.

### FIELD OF THE INVENTION

The present invention generally relates to a support apparatus, and more specifically to a foldable support apparatus, suitable for storage when folded and for supporting a portable electronic device on floor or in bed when expanded.

### BACKGROUND OF THE INVENTION

More and more people rely on portable electronic devices, such as, smart phone, tablet PC, and so on, for information and for entertainment. As audiovisual contents are becoming ubiquitous, many users are using portable devices for viewing visual contents, such as movies or clips.

In particular, many users enjoy lying comfortably in bed when viewing movies or playing with entertainment apps on portable devices. To enhance the comfort, several designs of bed tables are developed for placing such electronic devices and for convenient operation. However, the majority of bed tables usually has large-area table top and is often too large and inconvenient for using smaller devices, such as tablet PC or smart phone. Also, while many bed tables are designed to include foldable legs, the large-area table top is unsuitable for storage. Therefore, many users still use hand to hold the portable device when operating the devices in bed. As such, it is desirable to devise a support apparatus suitable for convenient placement and operation of portable electronic device in the comfort of bed.

### SUMMARY OF THE INVENTION

The primary object of the present invention is to provide a foldable support apparatus. When folded, the components of the support apparatus are neatly aligned side-by-side compactly to save storage space. When expanded, the support device forms a shape of ∩ (i.e., reverse U), wherein the top of ∩ can be disposed with a device or an object for placing and fastening a portable electronic device. When the foldable support apparatus of the present invention is placed in bed, on the ground or on the lawn, the user can lie in the center part of the ∩ so that the user easily operate the portable electronic device fastened to the top of ∩ of the support apparatus.

To achieve the aforementioned object, the present invention includes a join unit and a support frame. The shape of the joint unit depends on the device to be fixed to the joint unit. The support frame is coupled to the joint unit. The support frame includes two multi joint sets, with one multi joint set further including a first arm, a first leg and a first foot, and the other multi joint set including a second arm, a second leg and a second foot; wherein the first arm and the second arm both being connected to joint unit at one end; the first arm and the second arm being on a same straight line when expanded; the first leg having two ends, with one end coupled to the first arm and the other end coupled to the first foot; similarly, the second leg having two ends, with one end coupled to the second arm and the other end coupled to the second foot. When the support frame is expanded, the first leg, the first arm, the second arm and the second leg form a ∩-shape. The first foot coupled to the first leg and the second foot coupled to the second leg are responsible for supporting and maintaining the standing angle of the aforementioned ∩-shape. To fold, each of the components can rotate around the coupling position so that the components can aligned side-by-side to reduce the occupied space.

Furthermore, the foldable support apparatus of the present invention is to provide a frame as a base, and a device can be disposed at the joint unit to form a complete product; for example, the joint unit can be used with a carrying device. The carrying device includes a first carrying plate, a second carrying plate and an angle-adjusting element. The two carrying plates are disposed to the joint unit through the angle-adjusting element. The two carrying plates can rotate around the coupling position in opposite directions to expand. When the two carrying plates rotate towards each other and become aligned side-by-side, the two carrying plates form a flat carrying surface for placing portable electronic device. The angle-adjusting element further includes a lock disposed at the coupling position of the two carrying plates. When lock is released, the two carrying plates can perform angle adjustment. When the lock is locked, the positions of the two carrying plates are fixed.

In addition, the foldable support apparatus of the present invention can also be used with a spherical connection base to become a complete product. The spherical connection base is disposed at the joint unit, and the spherical connection base includes a spherical connector, a sphere-carrying base and a rotational button fixing element. The spherical connector is disposed inside the sphere-carrying base, and the rotational button fixing element is engaged to the outside of the sphere-carrying base. When the rotational button fixing element rotates to the lock position, the spherical connector is fixed and unable to move. When the rotational button fixing element rotates to a loosened position, the spherical connector can rotate for angle adjustment. Also, the spherical connector includes a buckle plate at the other end away from position connected to the sphere-carrying base for providing engagement and fixation other holding device. When in use, the holding device can hold and fix portable electronic device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention in folded state;

FIG. 2 shows a schematic view of the present invention in expanded state;

FIG. 3 shows a schematic view of the present invention during expansion process;

FIG. 4 shows a schematic view of the present invention during expansion process;

FIG. 5 shows a schematic view of the present invention used with a carrying device in a folded state;

FIG. 6 shows a schematic of the present invention used with a carrying device during expansion process;

FIG. 7 shows a schematic of the present invention used with a carrying device when fully expanded;

FIG. 8 shows a side view of the present invention when in actual application;

FIG. 9 shows a schematic view of the present invention used with a spherical connection base; and

FIG. 10 shows a schematic view of the present invention used with a spherical connection base in expanded state.

### DETAILED DESCRIPTION OF THE PREFERRED EMBODIMENTS

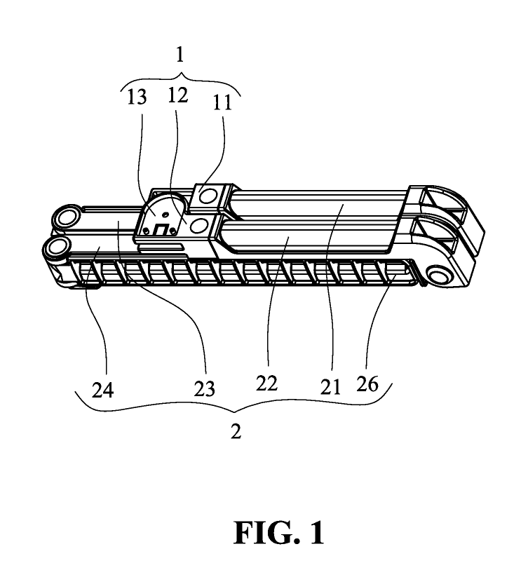

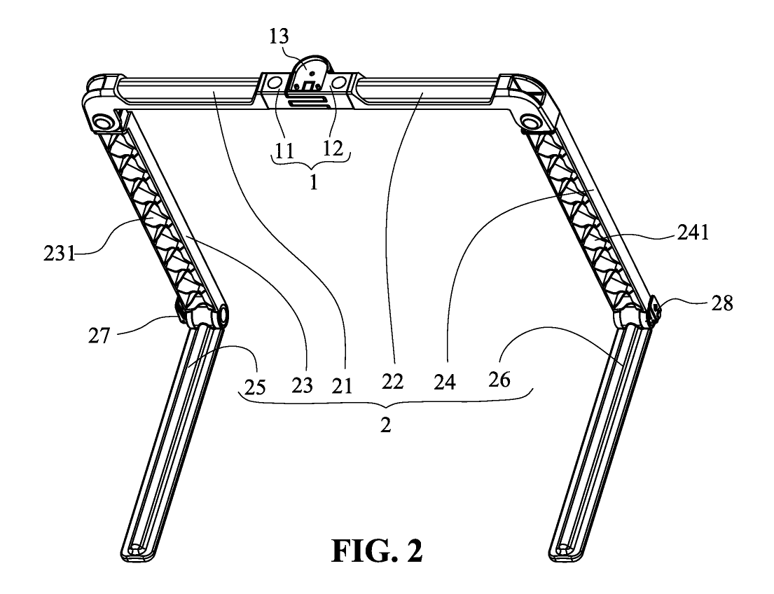

FIG. 1 and FIG. 2 show schematic views of the foldable support apparatus of the present invention in folded and expanded states respectively. The support apparatus in the figures is a frame used as a base. In actual application the present invention can be used with additional devices. The support apparatus of the present invention includes a joint unit 1 and a support frame 2. Majority of joint unit 1 is to couple with support frame 2, and the remaining part is for the additional devices to be used with. For example, when the additional device is a spherical connection base or a carrying device, the remaining part may be different. The present invention is not limited to specific shape of the remaining part as long as additional devices can be used with.

Joint unit 1 includes a first element 11 and a second element 12 coupled together. The coupling position of first element 11 and second element 12 is formed by connecting a plurality of connection plates disposed with interval, and an axis (not shown) penetrates the plurality of splicing plates so that first element 11 and second element 12 can rotate around the axis. Because the coupling structure is a common design, the joint unit 1 of the present invention is not limited to the embodiment shown in the figure. The only restriction on joint unit 1 is that the maximum angle to open up is 180°, that is, the maximum angle between first element 11 and second element 12 is 180° so that first element 11 and second element 12 can be on a same straight line.

Support frame 2 is disposed on joint unit 1 and includes two sets of multi-joint components so that each component can aligned side-by-side when folded to save storage space. When expanded, the structure form a ∩ shape. Joint unit 1 is located at the top point of the ∩ shape.

Support frame 2 includes a first arm 21, a second arm 22, a first leg 23, a second leg 24, a first foot 25 and a second foot 26. One end of first arm 21 and second arm 22 is connected to joint unit 1; that is, first arm 21 is connected to first element 11 and second arm 22 is connected to second element 12. As such, the two arms can be close together side-by-side when folded. When expanded, the maximum angle between first arm 21 and second arm 22 is 180° so that first arm 21 and second arm 22 can be aligned on a same straight line.

First leg 23 has two ends, with one end coupled to first arm 21 and the other end coupled to first foot 25. The coupling position of first leg 23 and first arm 21 is located at the other end of the coupling position of first arm 21 and joint unit 1. First leg 23 can rotate in a specific direction around the coupling position with first arm 21, and first arm 21 can also rotate in a specific direction around the coupling position with joint unit 1. The above to rotation directions are perpendicular to each other. Similarly, second leg 24 has two ends, with one end coupled to second arm 22 and the other end coupled to second foot 26. The coupling position of second leg 24 and second arm 22 is located at the other end of the coupling position of second arm 22 and joint unit 1. Second leg 24 can rotate in a specific direction around the coupling position with second arm 22, and second arm 22 can also rotate in a specific direction around the coupling position with joint unit 1. The above to rotation directions are perpendicular to each other. As such, when the present invention expands, first leg 23, first arm 21, second arm 22 and second leg 24 form the ∩ shape.

One of side walls on the circumference of first leg 23 is not closed, and forms an open first space 231. First space 231 is for accommodating first foot 25 when folded. Similarly, one of side walls on the circumference of second leg 24 is not closed, and forms an open second space 241. Second space 241 is for accommodating second foot 26 when folded. As such, when folded, the size of the present invention is further reduced.

First foot 25 is coupled to the one end of first leg 23 away from first arm 21, and second foot 26 is coupled to the one end of second leg 24 away from second arm 22. The two feet are for supporting and maintaining the angle of the ∩ shape when standing. To enhance stability, when in standing position, the angle between first foot 25 and first leg 23 and the angle between second foot 26 and second leg 24 are preferably less than 90°, that is, acute angles, so that the center of mass will fall within the range between first foot 25 and second foot 26 to avoid tipping over. In addition, for adjustment and fixation of the above angles, the coupling position between first foot 25 and first leg 23 has a first lock 27, and the coupling position between second foot 26 and second leg 24 has a second lock 28. When first lock 27 is unlocked, the angle between first foot 25 and first leg 23 can be adjusted. On the other hand, when first lock 27 is locked, the angle is fixed. Similarly, second lock 28 provides the same functionality.

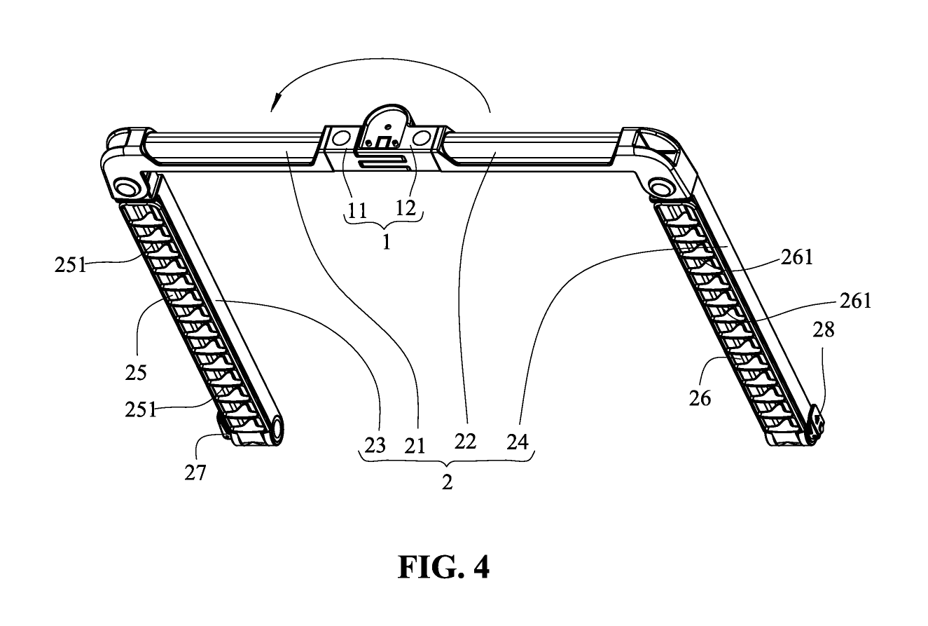

In addition, first foot 25 includes a first sole and second foot 26 includes a second sole. The first sole and the second sole are the part contacting the surface where the first foot 25 and second foot 26 are placed on when standing. Because the present invention is mainly designed to be used in bed, the first sole and the second sole are designed as non-flat surface, such as a curvy surface. One embodiment of the design is shown in FIG. 4. In FIG. 4, the first sole includes a plurality of arc plates 251 disposed with intervals, and the second sole includes a plurality of arc plates 261 disposed with intervals. When standing in bed, the present invention can still stand stably with first foot and second foot on the soft surface of the bed.

Furthermore, to ensure that first arm 21, second arm 22, first leg 23 and second leg 24 can be precisely positioned and fixed during rotation for expansion or folding, the present invention also disposes resilient positioning elements inside the coupling position for additional convenience.

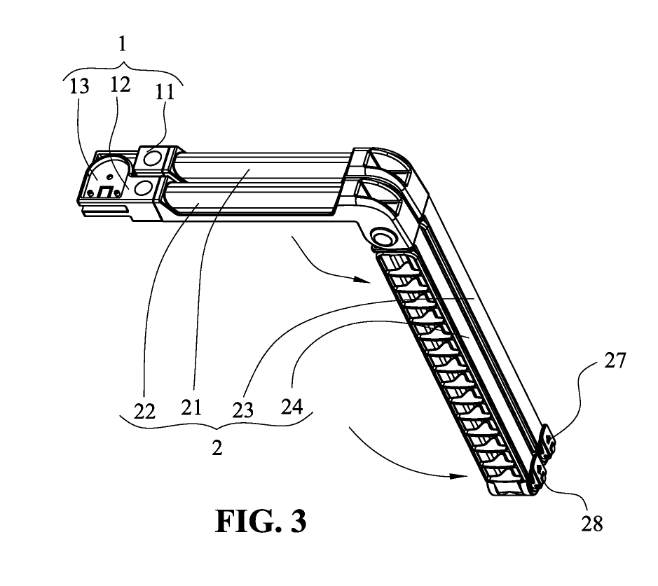

The following describes the folding and expansion of the present invention. As shown in FIG. 1, the support apparatus of the present invention is in the folded state. At this point, first arm 21 and second arm 22 coupled to joint unit 1 are aligned closed together. First leg 23 is aligned next to first arm 21. First foot 25 is housed inside first space 231 of first leg 23. Similarly, second leg 24 is aligned next to second arm 22. second foot 26 is housed inside second space 241 of second leg 24. As such, when folded, the overall size of the present invention is small. For expansion, as shown in FIG. 3, pull down first leg 23 and second leg 24. Then, as shown in FIG. 4, pull first arm 21 in the direction away from second arm 22. Finally, as shown in FIG. 2, pull first foot 25 to form an acute angle or right angle with first leg 23, and pull second foot 26 to form an acute angle or right angle with second leg 24. As such, the support apparatus of the present invention stands in the ∩ shape.

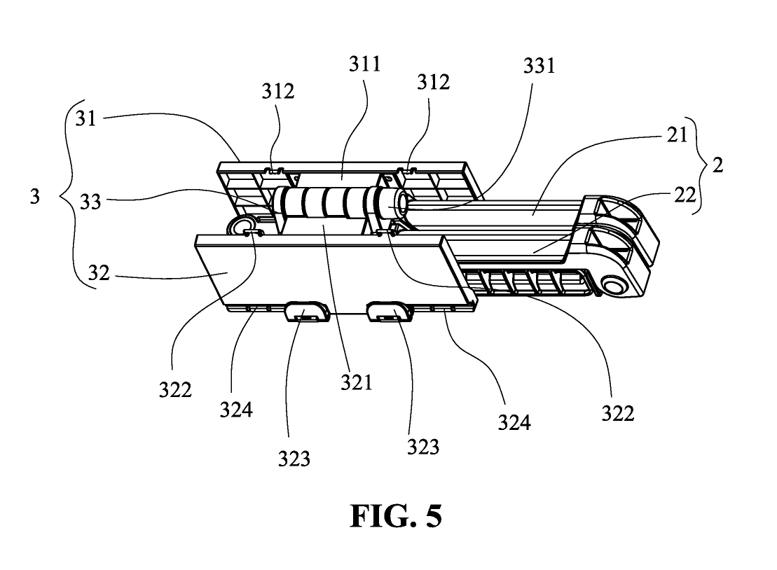

As aforementioned, the support apparatus is a support frame that can be used as a base to collaborate with another device disposed at joint unit 1. The following embodiment shows a carrying device 3 used with the support apparatus of the present invention. As shown in FIG. 1, joint unit 1 further includes a carrying base 13. In the present embodiment, carrying base 13 is located on side wall of second element 12, as shown in FIG. 5. Carrying base 13 is disposed with a carrying device 3, which can be screwed or glued to carrying base 13. Carrying device 3 includes a first carrying plate 31, a second carrying plate 32 and an angle-adjusting element 33. The two carrying plates are disposed to joint unit 1 through angle-adjusting element 33. The two carrying plates and angle-adjusting element 33 are assembled in the following manner: first carrying plate 31 extending an articulated part 311 and second carrying plate extending an articulated part 321; articulated parts 311, 321 are coupled to an axis element to angle-adjusting element 33. The axis element is hidden inside the structure. Because first carrying plate 31 and second carrying plate 32 are rotate around axis element, to prevent two carrying plates from unwanted rotation, angle-adjusting element 33 includes an angle-lock 331 at one end of axis element. When angle-lock 331 is unlocked, the two carrying plates can be adjusted for different angles. When angle-lock 331 is locked, the two carrying plates are fixed.

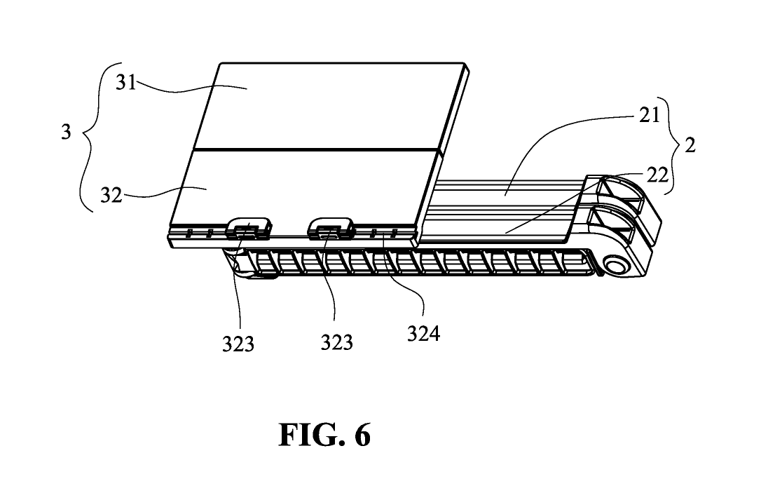

As shown in FIG. 5, when not in use, two carrying plates can rotate in opposite direction so that first carrying plate 31 is on outer side of first arm 21 and second carrying plate is on outer side of second arm 22 to reduce the size. As shown in FIG. 6, when in use, first carrying plate 31 and second carrying plate 32 rotate towards each other around axis element to be close together to form a flat carrying surface for placing electronic device. Because during adjustment, two carrying plates must adjust angle simultaneously, as shown in FIG. 5, at least one side wall of circumference of first carrying plate 31 forms at least a buckle element 312, and at least one side wall of circumference of second carrying plate 32 forms at least an engaging element 322. When first carrying plate 31 and second carrying plate 32 are close together, buckle element 312 is engaged to engaging element 322 so that first carrying plate 31 and second carrying plate 32 cannot be separated. For angle adjustment, the structure formed by first carrying plate 31 and second carrying plate 32 can be adjusted simultaneously. Also, at least a stop block 323 and at least a slide track 324 are disposed on the plate surface of second carrying plate 32 away from the part contacting first carrying plate 31. Stop block 323 can slide on slide track 324 to adjust the position. Stop block 323 can protrude from the surface of second carrying plate 32 when flipped to prevent electronic device from sliding off second carrying plate 32.

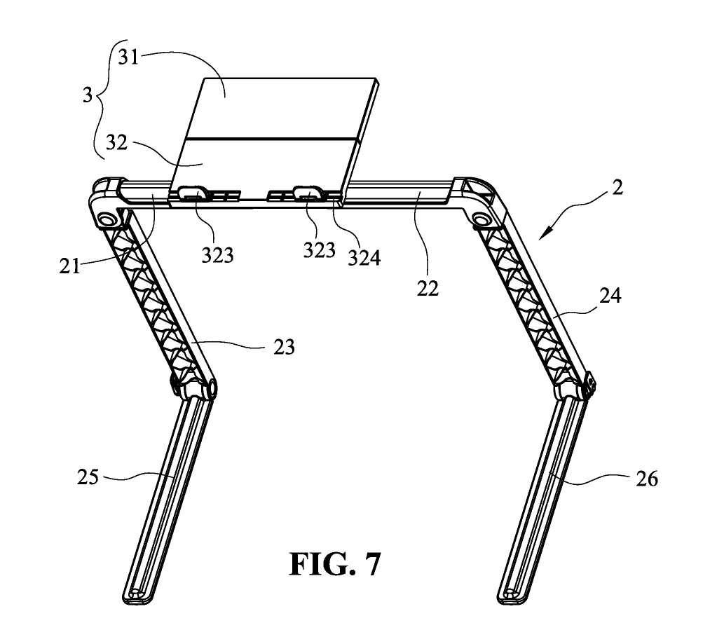

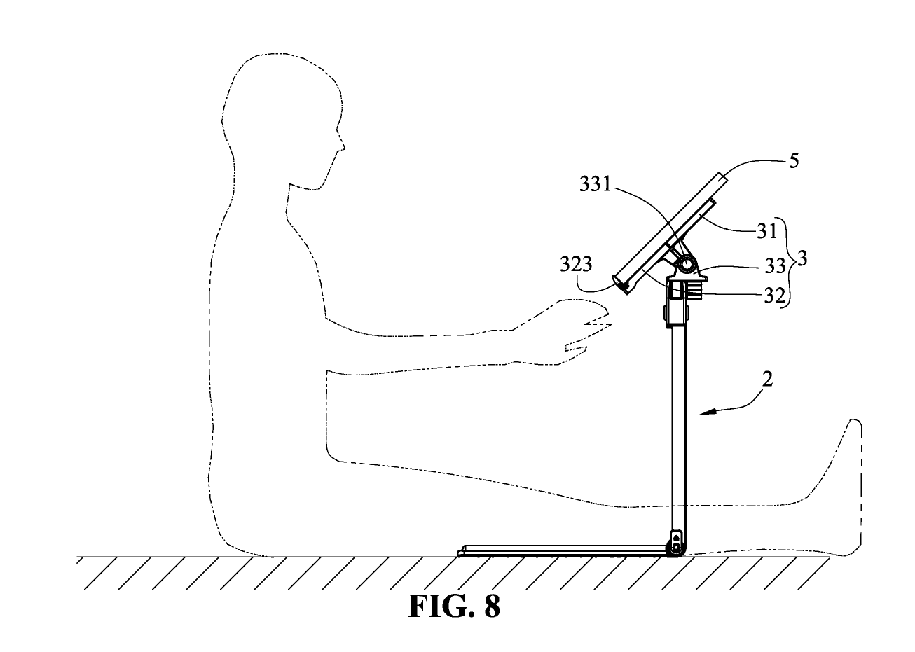

The following describes the use of the present invention when expanded. The expansion process is similar to the aforementioned expansion process except that, in the present embodiment, first carry plate 31 and second carrying plate 32 of carrying device 3 must be rotated, as shown in FIG. 6, to be aligned close together. The subsequent operation is the same as shown in FIG. 3 and FIG. 4. The final expanded view is shown in FIG. 7 and FIG. 8. Portable electronic device 5 is placed on the surface formed by first carrying plate 31 and second carrying plate 32. Stop block 323 is flipped to protrude from surface of second carrying plate 32 to prevent portable electronic device 5 from sliding off. To adjust the angle of the two carrying plates, angle-lock 331 is unlocked, the angle of the carrying plates is adjusted, and angle-lock 331 is locked. The user is situated between the two legs of ∩ shape so that the user can use the portable device in bed comfortably.

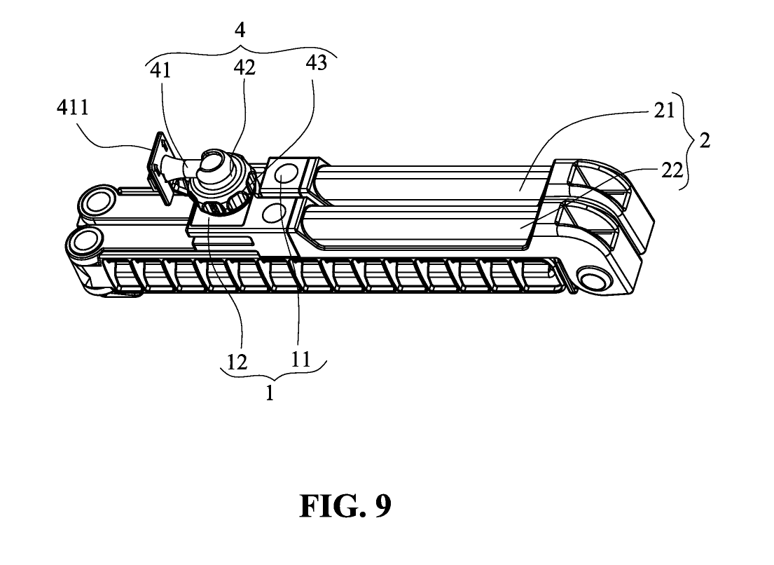

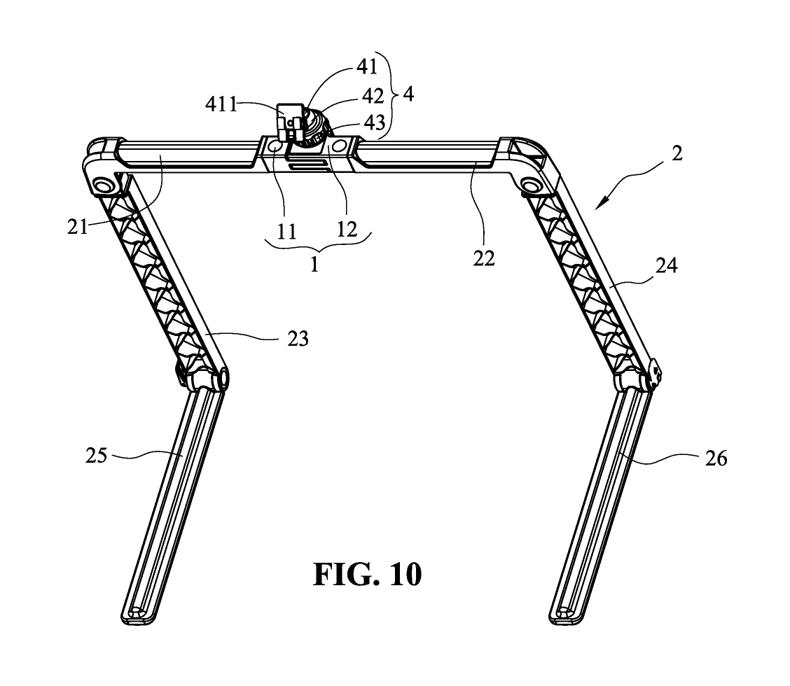

The following describes anther embodiment of the support apparatus of the present invention used with a spherical connection base. As shown in FIG. 9 and FIG. 10, a spherical connection base 4 is disposed to joint unit 1 for clamping portable electronic device. Spherical connection base 4 includes a spherical connector 41, a sphere-carrying base 42 and a rotational button fixing element 43. Sphere-carrying base 42 is formed directly on second element 12 of joint unit 1. One end of spherical connector 41 is a sphere and is coupled inside the sphere-carrying base 42. Rotational button fixing element 43 is engaged to the outside of the sphere-carrying base 42. When the rotational button fixing element 43 rotates to the lock position, the spherical connector 41 is fixed and unable to move. When the rotational button fixing element 43 rotates to a loosened position, the spherical connector 41 can rotate for angle adjustment. Also, the spherical connector 41 includes a buckle plate 411 at the other end away from position connected to the sphere-carrying base 42 for providing engagement and fixation other holding device. The shape of buckle plate 411 depends on the holding device. When in use, the holding device can hold and fix portable electronic device.

As such, with the support apparatus of the present invention as a base, different devices can be disposed to joint unit to hold or carry different portable electronic devices for the user to view or operate in bed comfortably. When folded, all the components of the present invention can be neatly aligned close together to reduce the size and easy for storage. When expanded, the structure shows a ∩ shape so that the user can use the portable device in bed comfortably.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A foldable support apparatus, comprising:
a join unit and a support frame; said support frame being coupled to the joint unit, said support frame comprising two multi joint sets, with one multi-joint set further comprising a first arm, a first leg and a first foot, and the other multi joint set comprising a second arm, a second leg and a second foot; wherein said first arm and said second arm both being connected to joint unit at one end; said first arm and said second arm being on a same straight line when expanded; said first leg having two ends, with one end coupled to said first arm and the other end coupled to said first foot; similarly, said second leg having two ends, with one end coupled to said second arm and the other end coupled to said second foot; and
when the support frame being expanded, said first leg, first arm, second arm and second leg forming a ∩-shape; said first foot coupled to said first leg and said second foot coupled to said second leg being responsible for supporting and maintaining a standing angle of said ∩-shape; when folded, each of components able to rotate around coupling position so that said components able to align side-by-side to reduce occupied space.

2. The foldable support apparatus as claimed in claim 1, wherein coupling position of said first foot and said first leg is disposed with a first lock, coupling position of said second foot and said second leg is disposed with a second lock, when said first lock is locked, angle between said first foot and said first leg is fixed, and when said second lock in locked, angle between said second foot and said second leg is fixed.

3. The foldable support apparatus as claimed in claim 1, wherein one of side walls on circumference of said first leg is open to form an open first space, said first foot is accommodated inside said first space when folded; one of side walls on circumference of second leg is open to form an open second space, said second foot is accommodated inside said second space when folded.

4. The foldable support apparatus as claimed in claim 1, wherein said first foot comprises a first sole and said second foot comprises a second sole; said first sole and said second sole are the part contacting a surface where said first foot and said second foot arc placed on when standing; said first sole and said second sole are curvy surfaces.

5. The foldable support apparatus as claimed in claim 4, wherein said first sole comprises a plurality of arc plates disposed with intervals, and said second sole also comprises a plurality of arc plates disposed with intervals.

6. The foldable support apparatus as claimed in claim 1, wherein said joint unit is further engaged to a carrying device, said carrying device comprises a first carrying plate, a second carrying plate and an angle-adjusting element; said two carrying plates are disposed onto joint unit through angle-adjusting element; said two carrying plates are coupled to said angle-adjusting element; said two carrying plates can rotate in opposite direction around coupling position to open; said two carrying plates can be close together to form a flat carrying surface; said angle-adjusting element further comprises a lock for fixing angle of two said carrying plates on said angle-adjusting element.

7. The foldable support apparatus as claimed in claim 6, wherein at least one side wall of circumference of said first carrying plate forms at least a buckle element, and at least one side wall of circumference of said second carrying plate forms at least an engaging element; when said first carrying plate and said second carrying plate are close together, said buckle element is engaged to said engaging element so that said first carrying plate and said second carrying plate form a flat carrying surface.

8. The foldable support apparatus as claimed in claim 6, wherein at least a stop block is disposed on surface of said second carrying plate away from the part contacting said first carrying plate 31, said stop block can be flipped to protrude from said surface of said second carrying plate.

9. The foldable support apparatus as claimed in claim 8, wherein at least a slide track is disposed on surface of said second carrying plate away from the part contacting said first carrying plate; said stop block can slide on said slide track to adjust position of said stop block on said second carrying plate.

10. The foldable support apparatus as claimed in claim 1, wherein said joint unit is engaged to a spherical connection base, said spherical connection base comprises a spherical connector, a sphere-carrying base and a rotational button fixing element; said sphere-carrying base is formed on said joint unit; one end of said spherical connector is a sphere and is coupled inside said sphere-carrying base; rotational button fixing element is engaged to outside of said sphere-carrying base; when said rotational button fixing element rotates to lock position, said spherical connector is fixed and unable to move; when said rotational button fixing element rotates to a loosened position, said spherical connector can rotate for angle adjustment; said spherical connector comprises a buckle plate at the other end away from position connected to said sphere-carrying base, shape of said buckle plate depends on a holding device.

11. A foldable support apparatus, comprising:
a join unit and a support frame; said support frame being coupled to the joint unit, said support frame comprising two multi joint sets, with one multi-joint set further comprising a first arm, a first leg and a first foot, and the other multi joint set comprising a second arm, a second leg and a second foot; wherein said first arm and said second arm both being connected to joint unit at one end; said first arm and said second arm being on a same straight line when expanded; said first leg having two ends, with one end coupled to said first arm and the other end coupled to said first foot; similarly, said second leg having two ends, with one end coupled to said second arm and the other end coupled to said second foot;
a carrying device being engaged to said joint unit, said carrying device comprising a first carrying plate, a second carrying plate and an angle-adjusting element; said two carrying plates being disposed onto joint unit through angle-adjusting element; said two carrying plates being coupled to said angle-adjusting element; said two carrying plates able to rotate in opposite direction around coupling position to open, or rotate towards each other to be close; said two carrying plates able to be close together to form a flat carrying surface; said angle-adjusting element further comprising a lock for fixing angle of two said carrying plates on said angle-adjusting element; and
when the support frame being expanded, said first leg, first arm, second arm and second leg forming a ∩-shape; said first foot coupled to said first leg and said second foot coupled to said second leg being responsible for supporting and maintaining a standing angle of said ∩-shape; when folded, each of components able to rotate around coupling position so that said components able to align side-by-side to reduce occupied space.

12. A foldable support apparatus, comprising:
a join unit and a support frame; said support frame being coupled to the joint unit, said support frame comprising two multi-joint sets, with one multi joint set further comprising a first arm, a first leg and a first foot, and the other multi joint set comprising a second arm, a second leg and a second foot; wherein said first arm and said second arm both being connected to joint unit at one end; said first arm and said second arm being on a same straight line when expanded; said first leg having two ends, with one end coupled to said first arm and the other end coupled to said first foot; similarly, said second leg having two ends, with one end coupled to said second arm and the other end coupled to said second foot;
a spherical connection base being engaged to said joint unit, said spherical connection base comprising a spherical connector, a sphere-carrying base and a rotational button fixing element; said sphere-carrying base is formed on said joint unit; one end of said spherical connector being a sphere and coupled inside said sphere-carrying base; rotational button fixing element being engaged to outside of said sphere-carrying base; when said rotational button fixing element rotating to lock position, said spherical connector being fixed and unable to move; when said rotational button fixing element rotating to a loosened position, said spherical connector able to rotate for angle adjustment; said spherical connector comprising a buckle plate at the other end away from position connected to said sphere-carrying base, shape of said buckle plate depending on a holding device; and
when the support frame being expanded, said first leg, first arm, second arm and second leg forming a ∩-shape; said first foot coupled to said first leg and said second foot coupled to said second leg being responsible for supporting and maintaining a standing angle of said ∩-shape; when folded, each of components able to rotate around coupling position so that said components able to align side-by-side to reduce occupied space.
